(19) United States
(12) Patent Application Publication
(10) Pub. No.: US 2021/0187987 A1
(43) Pub. Date: Jun. 24, 2021

(54) CORK STAMPING SYSTEM AND METHODS OF USE

(71) Applicant: Douglas E. Hatfield, Oro Valley, AZ (US)

(72) Inventor: Douglas E. Hatfield, Oro Valley, AZ (US)

(21) Appl. No.: 16/722,550

(22) Filed: Dec. 20, 2019

(51) Int. Cl. B41K 1/04; B41K 1/56

(52) U.S. Cl. CPC B41K 1/04; B41K 1/56

(57) ABSTRACT

Cork stamping systems for applying a label, a design, text, or other information to the outside surface of a cork. The systems feature a plier-style device with a pair of jaws at its terminating end. At least a portion of the jaws features a stamp, and the jaws are constructed to accept at least a portion of a cork, wherein when the cork is clamped between the jaws, the stamp stamps on or etches in a design on the cork.

### BACKGROUND OF THE INVENTION

### Field of the Invention

The present invention relates to devices for stamping cork, more particularly to hand-held devices for stamping corks or other materials with designs. As used herein, the term “cork” may be used interchangeably to define a stopper, whether it be natural or synthetic, in a wine bottle or other such container.

### Background Art

Cork is a natural material derived from a cork oak tree, and cork has been used for thousands of years as a stopper in bottles. For example, corks are inserted into wine bottles during the bottling process and remain within the bottle until removed by the consumer. Many corks include designs and designations stamped onto the corks to indicate the origin of the wine and the manufacturer thereof. The design and designation may be impressed upon a cork after it is cut to size. Sizes may be predominantly #7, #8, and size #9×1¾″ long corks. The cork designs may be placed anywhere on the side.

### BRIEF SUMMARY OF THE INVENTION

The present invention features cork stamping systems for the application of a design and/or text to a cork.

The present invention is not limited to the designs shown herein. The systems herein may feature any shape comfortable to the hand combined with the stamp portion with the curvatures described herein. For example, any design such but not limited to linesman's pliers (e.g., metal, plastic, etc.) with parallel jaws at +−⅞″ (e.g., for a #8 cork diameter) could be sufficient.

Further, the present invention is not limited to a system with a single stamp. The system may feature stamps on both jaws to provide two (or more) Images on the cork.

As an example, the cork stamping system of the present invention may comprise a first shaft component having a first end and a second end, wherein a first shaft handle is disposed at the first end and the second end terminates with a first jaw. The first jaw has an inner cavity disposed in its inner surface, wherein the inner cavity has a semi-cylindrical or partial semi-cylindrical shape and is for accepting at least a portion of a cork. The system may further comprise a second shaft component having a first end and a second end, wherein a second shaft handle is disposed at the first end and the second end terminates with a second jaw. The second jaw has an inner cavity disposed in its inner surface, wherein the inner cavity has a semi-cylindrical or partial semi-cylindrical shape and is for accepting at least a portion of a cork. The first jaw and second jaw are oriented such that the inner cavities face each other and a length of the inner cavity of the first shaft component as measured from its first end to its second end is parallel to a length of the inner cavity of the second shaft component as measured from its first end to its second end. The system further comprises a stamp disposed on at least a portion the inner cavity of the first shaft component. The stamp is for etching or imprinting into the surface of the cork. The first shaft component and second shaft component are mutually articulated connected by a hinge that allows the system to move between at least an open position wherein the jaws are separated such that a cork can be inserted into one of the inner cavities and a closed position wherein the jaws can sandwich a cork and apply pressure to the cork such that the stamp imprints or etches a design onto a surface of the cork.

In some embodiments, the inner cavities have an arc length and radius of curvature, wherein the arc length is from 1-10% less than π times the radius of curvature. In some embodiments, the inner cavities have an arc length and radius of curvature, wherein the arc length is from 10-20% less than π times the radius of curvature. In some embodiments, the inner cavities have an arc length and radius of curvature, wherein the arc length is from 1-20% less than π times the radius of curvature. In some embodiments, the inner cavities are from 25 to 75 mm in length as measured from its first end to its second end. In some embodiments, the inner cavities have a radius of curvature from 7-14 mm. In some embodiments, the inner cavities have an arc length from 20-45 mm.

In some embodiments, the first inner cavity has a first end and a second end opposite the first end, wherein the first end and second end are at least partially closed to prevent a cork housed in the first inner cavity from slipping through the first end or second end. In some embodiments, the second inner cavity has a first end and a second end opposite the first end, wherein the first end and second end are at least partially closed to prevent a cork housed in the second inner cavity from slipping through the first end or second end.

In some embodiments, the handles are ring handles. However, the handles are not limited to ring handles and may be any appropriate design that is comfortable to the user.

In some embodiments, the system further comprises a stamp disposed on at least a portion the inner cavity of the second shaft component. In some embodiments, the system further comprises an inking system for applying ink to the stamp. In some embodiments, the inking system comprises a handle with an ink pad (e.g., a cylindrical ink pad) attached to a second end of the handle, wherein the ink pad is constructed from a material that can absorb ink and release ink onto the stamp when in contact with the stamp. In some embodiments, the ink pad is constructed from a sponge material or a foam with linen material.

The present invention also features a cork stamping system for applying a design to an outside surface of a cork, wherein the system comprises a handle having a first end and an opposite second end; a jaw system connected to the second end of the handle, wherein a hollow inner cavity for accepting a portion of a cork is disposed in a bottom surface of the jaw system, and wherein the bottom surface is opposite an end of the jaw system that attaches to the second end of the handle, and the inner cavity has a shape of a semi-cylinder or partial semi-cylinder. The system may further comprise a stamp disposed on at least a portion of the inner cavity, wherein the stamp can print or etch a design on a surface of the cork when pressure is applied to the cork via the handle.

In some embodiments, the inner cavity has an arc length and radius of curvature, wherein the arc length is from 1-10% less than π times the radius of curvature. In some embodiments, the inner cavity has an arc length and radius of curvature, wherein the arc length is from 10-20% less than π times the radius of curvature. In some embodiments, the inner cavities have an arc length and radius of curvature, wherein the arc length is from 1-20% less than π times the radius of curvature. In some embodiments, the inner cavity is from 25 to 75 mm in length as measured from its first end to its second end. In some embodiments, the inner cavity has a radius of curvature from 7-14 mm. In some embodiments, the inner cavity has an arc length from 20-45 mm.

In some embodiments, the inner cavity has a first end and a second end opposite the first end, wherein the first end and second end are at least partially closed to prevent a cork housed in the inner cavity from slipping through the first end or second end.

In some embodiments, the system further comprises an inking system for applying ink to the stamp, the inking system comprises a handle with an ink pad (e.g., a cylindrical ink pad attached to a second end of the handle, wherein the ink pad is constructed from a material that can absorb ink and release ink onto the stamp when in contact with the stamp. In some embodiments, the ink pad is constructed from a sponge material or a foam with linen material.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a side view of an embodiment of the cork stamping system of the present invention.

FIG. 2 shows a bottom view of an embodiment of the cork stamping system of the present invention.

FIG. 3 shows a top view of an embodiment of the cork stamping system of the present invention.

FIG. 4 shows a perspective view of an embodiment of the cork stamping system of the present invention.

FIG. 5 shows a detailed view of a jaw of the embodiment of the cork stamping system in FIG. 4.

FIG. 6 shows a first perspective view of an embodiment of the cork stamping system of the present invention.

FIG. 7 shows a side view of an embodiment of the cork stamping system of the present invention.

FIG. 8 shows a second perspective view of an embodiment of the cork stamping system of the present invention.

FIG. 9 shows a bottom view of an embodiment of the cork stamping system of the present invention.

FIG. 10 shows a side view of an inking system of the present invention.

FIG. 11 shows an alternative embodiment of the system of the present invention.

FIG. 12 shows an alternative handle to the system of the present invention.

FIG. 13 shows an alternative handle to the system of the present invention.

### DETAILED DESCRIPTION OF THE INVENTION

The present invention features cork stamping systems (100) for applying a label, a design, text, or other information to the outside surface of a cork.

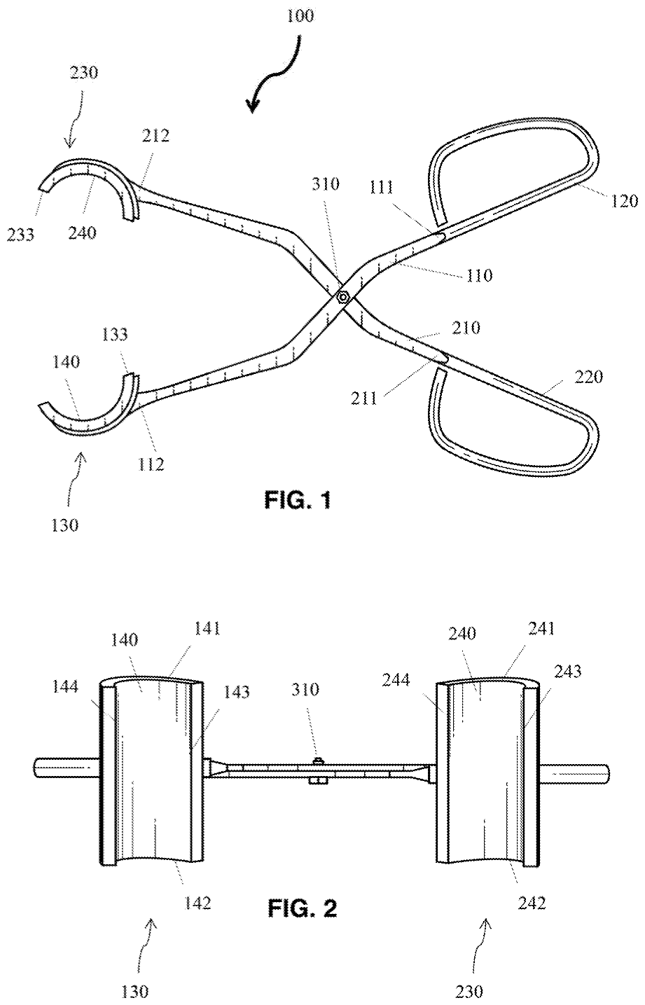

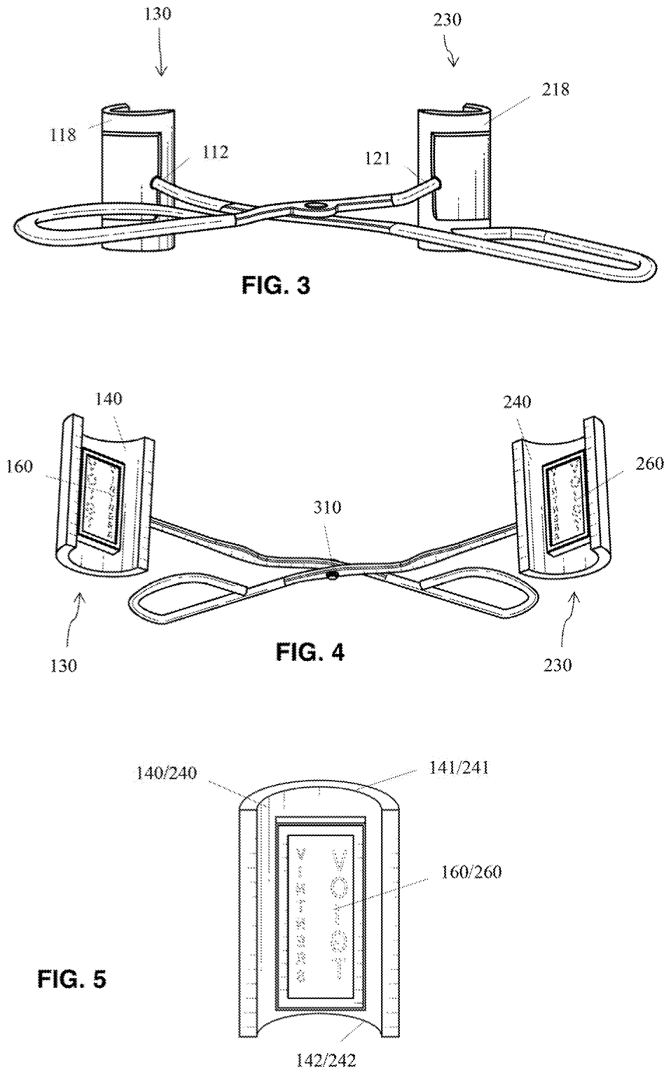

Referring to FIG. 1, FIG. 2, FIG. 3, and FIG. 4, in certain embodiments, the cork stamping system (100) is designed with a hinge and lever mechanism similar to scissors or pliers. For example, the system (100) may comprise a first shaft component (110) having a first end (111) and a second end (112) and a second shaft component (210) with a first end (211) and a second end (212). A first shaft handle (120) is disposed at the first end (111) of the first shaft component (110) and a second shaft handle (220) is disposed at the first end (211) of the second shaft component (210). The handles (120, 220) allow for a user to grip the system (100) and open and close the system, similar to a scissors mechanism or pliers mechanism. In certain embodiments, the handles (120, 220) are ring handles like those shown in FIG. 1. However, the present invention is not limited to ring handles.

Disposed on the second end (112) of the first shaft component (110) is a first jaw (130), and a second jaw (230) is disposed on the second send (212) of the second shaft component (210). The jaws have inner surfaces that face each other. The jaws are designed to hold and squeeze a cork therein between so as to imprint a design on the outer surface of the cork.

The shaft components (110, 210) are mutually articulated, connected by a hinge component (310). The system (100) can move between an open position and a closed position.

The jaws (130, 230) both feature a hollow inner cavity (140, 240) in the respective inner surfaces (133, 233) that is in the shape of a semi cylinder or variation thereof. FIG. 1. FIG. 2, FIG. 3, and FIG. 4 show the inner cavities of the jaws as being semi-cylindrical, however the system is not limited to an exact semi-cylindrical shape. For example, the arc lengths of the inner cavities (140, 240) may be less than what would be expected for an exact semi-cylinder (e.g., half the perimeter of a circle based on its radius of curvature). As a non-limiting example, if the radius of curvature of the inner cavities was 11 mm and the inner cavity was an exact semi-cylinder shape, the arc length would be expected to be 34.5 mm (half the perimeter of a cylinder based on the radius of curvature of 11 mm). However, the arc length may be less than 34.5, e.g., in certain embodiments, the shape of the inner cavity is a portion of a semi-cylinder (e.g., smaller than a semi-cylinder). In certain embodiments, the arc length is from 1-10% less than the expected semi-cylindrical arc length based on its radius of curvature (the expected semi-cylindrical arc length being n times the radius of curvature). In certain embodiments, the arc length is from 5-15% less than the expected semi-cylindrical arc length based on its radius of curvature (the expected semi-cylindrical arc length being it times the radius of curvature). In certain embodiments, the arc length is from 10-20% less than the expected semi-cylindrical arc length based on its radius of curvature (the expected semi-cylindrical arc length being π times the radius of curvature). In certain embodiments, the arc length is from 20-30% less than the expected semi-cylindrical arc length based on its radius of curvature (the expected semi-cylindrical arc length being it times the radius of curvature). In certain embodiments, the arc length is from 30-40% less than the expected semi-cylindrical arc length based on its radius of curvature (the expected semi-cylindrical arc length being r times the radius of curvature). In certain embodiments, the arc length is from 40-50% less than the expected semi-cylindrical arc length based on its radius of curvature (the expected semi-cylindrical arc length being r times the radius of curvature).

The inner cavities (140, 240) are for accepting a portion of a cork. The inner cavities (140, 240) have a first end (141, 241) and an opposite second end (142, 242). The first end (141, 241) of the inner cavity (140, 240) may align with the top (or bottom) end of the cork, and the second end (142, 242) of the inner cavity (140, 240) may align with the bottom (or top) end of the cork. The inner cavities (140, 240) have side edges, e.g., a first side edge (143, 243) and a parallel second side edge (144, 244).

In certain embodiments, the inner cavities (140, 240) may be from 25 to 50 mm in length (e.g., as measured from the first end (141, 241) to the second end (142, 242)). The inner cavities (140, 240) may be from 30 to 60 mm in length (e.g., as measured from the first end (141, 241) to the second end (142, 242)). The inner cavities (140, 240) may be from 40 to 50 mm in length (e.g., as measured from the first end (141, 241) to the second end (142, 242)). The inner cavities (140, 240) may be from 50 to 75 mm in length (e.g., as measured from the first end (141, 241) to the second end (142, 242)). The present invention is not limited to the aforementioned dimensions.

In certain embodiments, the inner cavity has a radius of curvature from 7-9 mm. In certain embodiments, the inner cavity has a radius of curvature from 8-10 mm. In certain embodiments, the inner cavity has a radius of curvature from 9-11 mm. In certain embodiments, the inner cavity has a radius of curvature from 10-12 mm. In certain embodiments, the inner cavity has a radius of curvature from 11-13 mm. In certain embodiments, the inner cavity has a radius of curvature from 12-14 mm. The present invention is not limited to the aforementioned dimensions.

In some embodiments, the inner cavities have an arc length from 20 to 25 mm. In some embodiments, the inner cavities have an arc length from 25 to 30 mm. In some embodiments, the inner cavities have an arc length from 30 to 35 mm. In some embodiments, the inner cavities have an arc length from 35 to 40 mm. In some embodiments, the inner cavities have an arc length from 40 to 45 mm. The present invention is not limited to the aforementioned dimensions.

A first stamp (160) is disposed on at least a portion of at least one inner cavity (140, 240). FIG. 4 shows a first stamp (160) disposed on the inner cavity (140) of the first jaw (130) and a second stamp (260) disposed on the inner cavity (240) of the second jaw (230). The stamps may be traditional stamps that can be coated with ink, or any other appropriate type of stamp. For example, in certain embodiments, the stamp is for etching or imprinting into the surface of the cork.

As previously discussed, the shaft components (110, 210) are mutually articulated connected by a hinge (310) that allows the system (100) to move between at least an open position wherein the jaws (130, 230) are separated such that a cork can be inserted into one of the inner cavities (140, 240) and a closed position wherein the jaws (130, 230) can sandwich a cork and apply pressure to the cork such that the stamp (160) imprints or etches a design onto a surface of the cork.

In certain embodiments, the jaws are constructed as shown in FIG. 1, FIG. 2, FIG. 3, and FIG. 4. For example, as shown in FIG. 3, the second ends of the shaft components connected to a semi-cylindrical (or partial semi-cylindrical) component that has an outer surface (118, 218) that is similar in shape to the inner cavities. However, the present invention is not limited to jaws with outer surfaces that are curved. Any appropriate jaw shape may be considered that still features the appropriate inner cavities (140, 240) disposed therein.

Referring to FIG. 5, in certain embodiments, the inner cavity has an open first end (141, 241) and/or an open second end (142, 242). However, the present invention is not limited to this configuration, and the first ends (141, 241) and/or second ends (142, 242) may be closed or partially closed, e.g., to prevent slippage of the cork through the first or second ends. In certain embodiments, the stamp (160) is centered in the inner cavity. However, the present invention is not limited to this particular placement of the stamp (160). The stamp (160) may be placed anywhere within the inner cavity as desired.

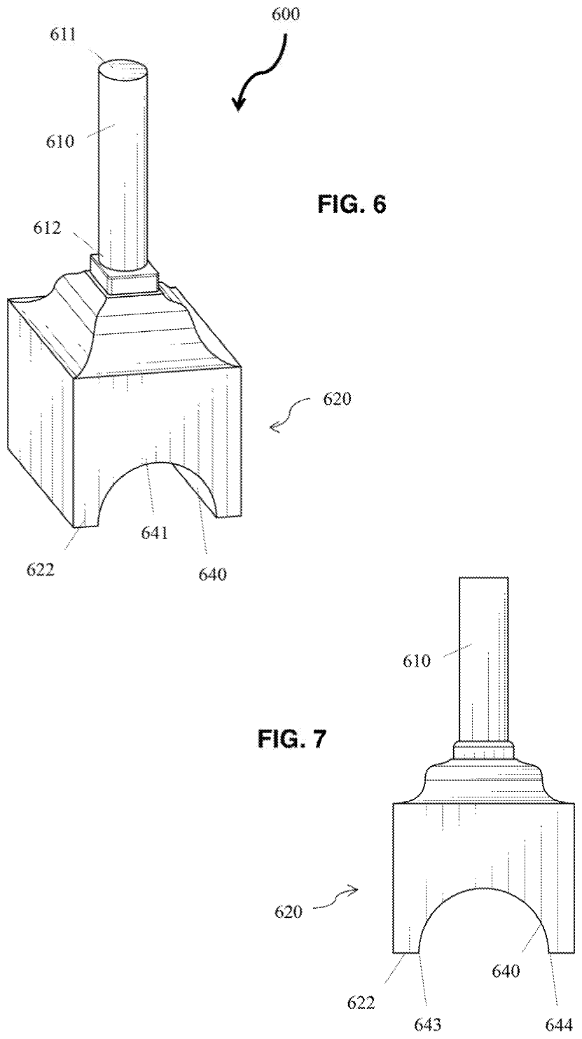

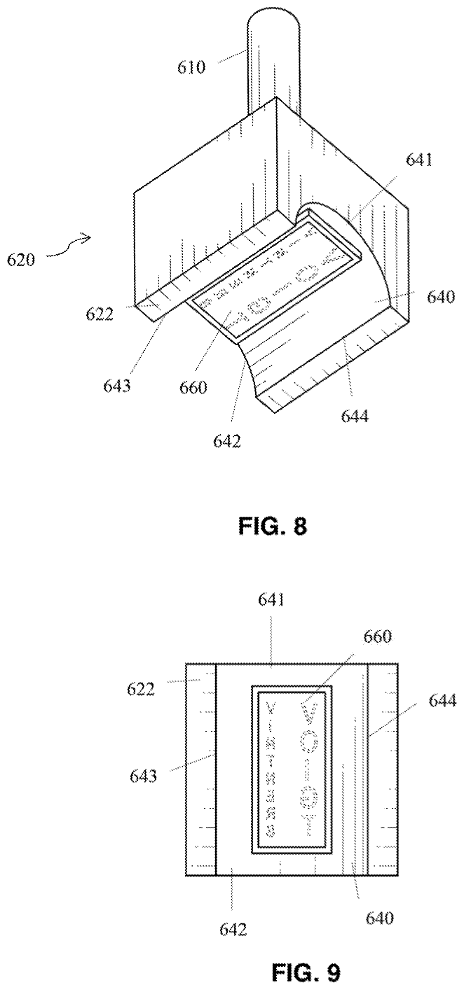

Referring to FIG. 6, FIG. 7, FIG. 8, and FIG. 9, in certain embodiments, the cork stamping system (600) comprises a handle (610) having a first end (611) and an opposite second end (612) terminating with a jaw system (620). The jaw system (620) has a bottom surface (622) opposite the end of the jaw system (620) connected to the second end (612) of the handle (110).

The jaw system (620) features a hollow inner cavity (640) disposed in the bottom surface (622) that is in the shape of a semi cylinder or variation thereof. FIG. 6 and FIG. 7 show the inner cavity (640) of the jaw system (620) as being semi-cylindrical, however the system is not limited to an exact semi-cylindrical shape. For example, the arc length of the inner cavity (640) may be less than what would be expected for an exact semi-cylinder (e.g., half the perimeter of a circle based on its radius of curvature). In certain embodiments, the arc length is from 1-10% less than the expected semi-cylindrical arc length based on its radius of curvature (the expected semi-cylindrical arc length being n times the radius of curvature). In certain embodiments, the arc length is from 5-15% less than the expected semi-cylindrical arc length based on its radius of curvature (the expected semi-cylindrical arc length being it times the radius of curvature). In certain embodiments, the arc length is from 10-20% less than the expected semi-cylindrical arc length based on its radius of curvature (the expected semi-cylindrical arc length being it times the radius of curvature). In certain embodiments, the arc length is from 20-30% less than the expected semi-cylindrical arc length based on its radius of curvature (the expected semi-cylindrical arc length being it times the radius of curvature). In certain embodiments, the arc length is from 30-40% less than the expected semi-cylindrical arc length based on its radius of curvature (the expected semi-cylindrical arc length being 7 times the radius of curvature). In certain embodiments, the arc length is from 40-50% less than the expected semi-cylindrical arc length based on its radius of curvature (the expected semi-cylindrical arc length being r times the radius of curvature).

The inner cavity (640) is for accepting a portion of a cork. The inner cavity (640) has a first end (641) and an opposite second end (642). The first end (641) of the inner cavity (640) may align with the top (or bottom) end of the cork, and the second end (642) of the inner cavity (640) may align with the bottom (or top) end of the cork. The inner cavity (640) has side edges, e.g., a first side edge (643) and a parallel second side edge (644).

In certain embodiments, the inner cavity (640) may be from 25 to 50 mm in length (e.g., as measured from the first end (641) to the second end (642)). The inner cavity (640) may be from 30 to 60 mm in length (e.g., as measured from the first end (641) to the second end (642)). The inner cavity (640) may be from 40 to 50 mm in length (e.g., as measured from the first end (641) to the second end (642)). The inner cavity (640) may be from 50 to 75 mm in length (e.g., as measured from the first end (641) to the second end (642)). The present invention is not limited to the aforementioned dimensions.

In certain embodiments, the inner cavity (640) has a radius of curvature from 7-9 mm. In certain embodiments, the inner cavity (640) has a radius of curvature from 8-10 mm. In certain embodiments, the inner cavity (640) has a radius of curvature from 9-11 mm. In certain embodiments, the inner cavity (640) has a radius of curvature from 10-12 mm. In certain embodiments, the inner cavity (640) has a radius of curvature from 11-13 mm. In certain embodiments, the inner cavity (640) has a radius of curvature from 12-14 mm. The present invention is not limited to the aforementioned dimensions.

In some embodiments, the inner cavity (640) has an arc length from 20 to 25 mm. In some embodiments, the inner cavity (640) has an arc length from 25 to 30 mm. In some embodiments, the inner cavity (640) has an arc length from 30 to 35 mm. In some embodiments, the inner cavity (640) has an arc length from 35 to 40 mm. In some embodiments, the inner cavity (640) has an arc length from 40 to 45 mm. The present invention is not limited to the aforementioned dimensions.

A stamp (660) is disposed on at least a portion of the inner cavity (640) (see FIG. 8, FIG. 9). The stamp (660) may be a traditional stamp that can be coated with ink, or any other appropriate type of stamp. For example, in certain embodiments, the stamp (660) is for etching or imprinting into/onto the surface of the cork. When a cork is inserted into the inner cavity (640) of the jaw system (620) and pressure is applied, the stamp (660) imprints or etches a design onto a surface of the cork.

In certain embodiments, the jaw system (620) is constructed as shown in FIG. 6, FIG. 7, FIG. 8, and FIG. 9. For example, in certain embodiments, the jaw system (620) is a box-like structure with an inner cavity (640) disposed therein. However, the present invention is not limited to the jaw configurations shown herein. Any appropriate jaw shape may be considered that still features the appropriate inner cavity (640) disposed therein.

Referring to FIG. 6, FIG. 7, and FIG. 8, in certain embodiments, the inner cavity has an open first end (641) and/or an open second end (642). However, the present invention is not limited to this configuration, and the first ends (641) and/or second ends (642) may be closed or partially closed, e.g., to prevent slippage of the cork through the first or second ends. In certain embodiments, the stamp (660) is centered in the inner cavity. However, the present invention is not limited to this particular placement of the stamp (660). The stamp (660) may be placed anywhere within the inner cavity as desired.

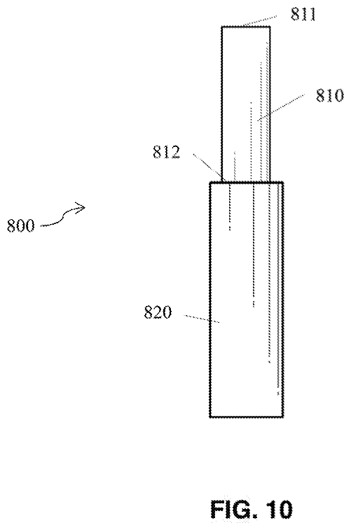

The present invention also features an inking system (800) for applying ink to the stamp (160, 660). As shown in FIG. 10, the inking system (800) may comprise a handle (810) with a first end (811) and a second end (812), and an ink pad (820) disposed on the second end (812). In certain embodiments, the ink pad (820) is a cylinder that can absorb ink (e.g., the ink pad (820) may be constructed from an absorbent material such as a sponge, foam with linen, or other appropriate material). The ink pad (820) may be attached to the handle (810) such that the ink pad (820) can rotate or spin (e.g., with respect to the handle (810)). The present invention is not limited to a cylindrical ink pad, and any appropriately shaped ink pad may be used. For example, in certain embodiments, the ink pad is a flat surface attached to the handle.

In certain embodiments, no ink is used on the stamp (160, 660). For example, the stamp may be used to etch or dig into the surface of the cork to create an or design.

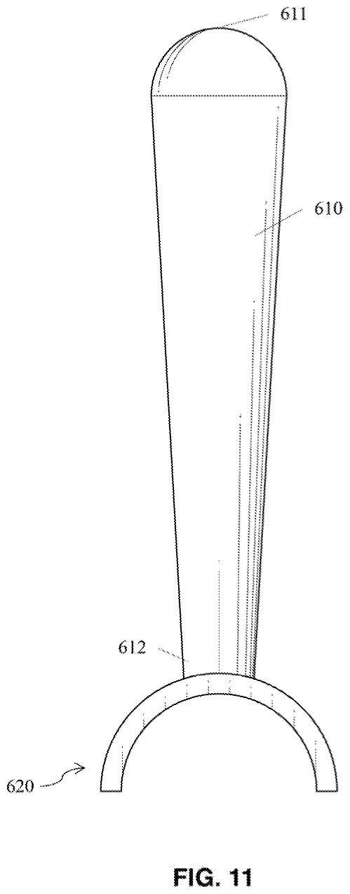

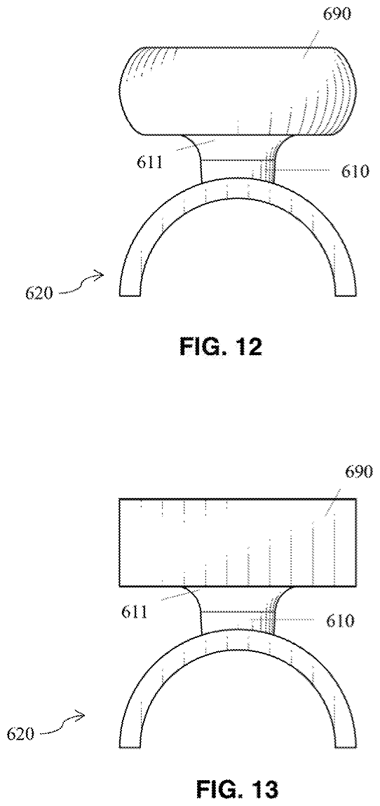

The present invention is not limited to the configurations shown in FIG. 1-10. The handles may be constructed in any design desired. e.g., any particular design that is comfortable for the user. For example, as shown in FIG. 11, in some embodiments, the handle (610) is tapered, e.g., the first end (611) has a larger diameter than that of the second end (612). As shown in FIG. 12 and FIG. 13, in certain embodiments, the handle (610) may feature a knob or gripping component (690) at the first end (611) of the handle (610).

Although there has been shown and described the preferred embodiment of the present invention, it will be readily apparent to those skilled in the art that modifications may be made thereto which do not exceed the scope of the appended claims. Therefore, the scope of the Invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A cork stamping system (100) for applying a design to an outside surface of a cork, said system comprising:
a. a first shaft component (110) having a first end (111) and a second end (112), a first shaft handle (120) is disposed at the first end (111) and the second end (112) terminates with a first jaw (130), the first jaw (130) has an inner cavity (140) disposed in its inner surface (133), the inner cavity (140) has a semi-cylindrical or partial semi-cylindrical shape and is for accepting at least a portion of a cork;
b. a second shaft component (210) having a first end (211) and a second end (212), a second shaft handle (220) is disposed at the first end (211) and the second end (212) terminates with a second jaw (230), the second jaw (230) has an inner cavity (240) disposed in its inner surface (233), the inner cavity (140) has a semi-cylindrical or partial semi-cylindrical shape and is for accepting at least a portion of a cork, wherein the first jaw (130) and second jaw (230) are oriented such that the inner cavities (140, 240) face each other and a length of the inner cavity (140) of the first shaft component (110) as measured from its first end (141) to its second end (142) is parallel to a length of the inner cavity (240) of the second shaft component (210) as measured from its first end (241) to its second end (242); and
c. a stamp (160) disposed on at least a portion the inner cavity (140) of the first shaft component (110), the stamp is for etching or imprinting into the surface of the cork;
wherein the first shaft component (110) and second shaft component (210) are mutually articulated connected by a hinge (310) that allows the system (100) to move between at least an open position wherein the jaws (130, 230) are separated such that a cork can be inserted into one of the inner cavities (140, 240) and a closed position wherein the jaws (130, 230) can sandwich a cork and apply pressure to the cork such that the stamp (160) imprints or etches a design onto a surface of the cork.

2. The system of claim 1, wherein the inner cavities (140, 240) have an arc length and radius of curvature, wherein the arc length is from 1-20% less than π times the radius of curvature.

3. The system of claim 1, wherein the inner cavities (140, 240) are from 25 to 75 mm in length as measured from its first end (641) to its second end (642).

4. The system of claim 1, wherein the inner cavities (140, 240) have a radius of curvature from 7-14 mm.

5. The system of claim 1, wherein the inner cavities (140, 240) have an arc length from 20-45 mm.

6. The system of claim 1, wherein the first inner cavity (140) has a first end (141) and a second end (142) opposite the first end (141), wherein the first end (141) and second end (142) are at least partially closed to prevent a cork housed in the first inner cavity (140) from slipping through the first end (141) or second end (142).

7. The system of claim 1, wherein the second inner cavity (240) has a first end (241) and a second end (242) opposite the first end (241), wherein the first end (241) and second end (242) are at least partially closed to prevent a cork housed in the second inner cavity (240) from slipping through the first end (241) or second end (242).

8. The system of claim 1, wherein the handles (120, 220) are ring handles.

9. The system of claim 1 further comprising a stamp disposed on at least a portion the inner cavity (240) of the second shaft component (210).

10. The system of claim 1 further comprising an inking system (800) for applying ink to the stamp (160).

11. The system of claim 10, wherein the inking system (800) comprises a handle (810) with an ink pad (820) attached to a second end (812) of the handle (810), wherein the ink pad (820) is constructed from a material that can absorb ink and release ink onto the stamp (160) when in contact with the stamp (160).

12. The system of claim 11, wherein the ink pad (820) is cylindrical.

13. A cork stamping system (600) for applying a design to an outside surface of a cork, said system comprising:
a. a handle (610) having a first end (611) and an opposite second end (612);
b. a jaw system (620) connected to the second end (612) of the handle (610), wherein a hollow inner cavity (640) for accepting a portion of a cork is disposed in a bottom surface (622) of the jaw system (620), the bottom surface (622) is opposite an end of the jaw system (620) that attaches to the second end (612) of the handle (610), the inner cavity (640) has a shape of a semi-cylinder or partial semi-cylinder; and
c. a stamp (660) disposed on at least a portion of the inner cavity (640), the stamp (660) can print or etch a design on a surface of the cork when pressure is applied to the cork via the handle (610).

14. The system of claim 13, wherein the inner cavity (640) has an arc length and radius of curvature, wherein the arc length is from 1-20% less than π times the radius of curvature.

15. The system of claim 13, wherein the inner cavity (640) is from 25 to 75 mm in length as measured from its first end (641) to its second end (642).

16. The system of claim 13, wherein the inner cavity (640) has a radius of curvature from 7-14 mm.

17. The system of claim 13, wherein the inner cavity (640) has an arc length from 20-45 mm.

18. The system of claim 13, wherein the inner cavity (640) has a first end (641) and a second end (642) opposite the first end (641), wherein the first end (641) and second end (642) are at least partially closed to prevent a cork housed in the inner cavity (640) from slipping through the first end (641) or second end (642).

19. The system of claim 13 further comprising an inking system (800) for applying ink to the stamp (660), the inking system (800) comprises a handle (810) with an ink pad (820) attached to a second end (812) of the handle (810), wherein the ink pad (820) is constructed from a material that can absorb ink and release ink onto the stamp (660) when in contact with the stamp (660).

20. The system of claim 19, wherein the ink pad (820) is cylindrical.
